(19) United States
(12) Patent Application Publication
(10) Pub. No.: US 2024/0418362 A1
(43) Pub. Date: Dec. 19, 2024

(54) STEAM GENERATION CONTROL METHOD

(71) Applicant: NEW WATT (FUJIAN) HIGH-TECH CO. LTD, Longyan (CN)

(72) Inventors: Zhaomin KE, Longyan (CN); Zhongwei ZHAO, Longyan (CN)

(21) Appl. No.: 18/821,997

(22) Filed: Aug. 30, 2024

Related U.S. Application Data
(63) Continuation of application No. PCT/CN2022/134325, filed on Nov. 25, 2022.

(30) Foreign Application Priority Data
Mar. 4, 2022 (CN) 202210206772.5
Mar. 4, 2022 (CN) 202210207081.7
Mar. 4, 2022 (CN) 202210207082.1

(51) Int. Cl. F22D 5/34; F22D 5/32

(52) U.S. Cl. CPC F22D 5/34; F22D 5/32

(57) ABSTRACT

Provided is a steam generation method for a steam generation system The method includes: S1, controlling the liquid pump (3) to operate, driving liquid from the liquid inlet (1) through the inlet valve (4) to the steam heater (5) in a heating state; S2, during the operation of the liquid pump (3), controlling the inlet valve (4) to alternately open and close at a preset frequency, causing the liquid to intermittently pass through the inlet valve (4). The liquid, after passing through the inlet valve (4), is delivered in a pulsed flow to the steam heater (5), where each pulsed flow continuously moves and is at least partially evaporated to produce steam before exiting the steam heater (5).

### CROSS REFERENCE OF RELATED APPLICATIONS

This application is a continuation of PCT Patent Application No. PCT/CN2022/134325, filed on 25 Nov. 2022, entitled “STEAM GENERATION CONTROL METHOD” which claims foreign priority of Chinese Patent Application No. 202210206772.5, filed 4 Mar. 2022, Chinese Patent Application No. 202210207081.7, filed 4 Mar. 2022, and Chinese Patent Application No. 202210207082.1, filed 4 Mar. 2022 in the China National Intellectual Property Administration (CNIPA), the entire contents of which are hereby incorporated by reference in their entireties.

### TECHNICAL FIELD

This application relates to the technical field of steam generation, and more particularly, to a steam generation control method.

### BACKGROUND OF THE INVENTION

Steam has the characteristics of high temperature and the ability to produce a large amount of steam from a small amount of liquid water, making it widely applicable in fields such as cleaning, disinfection, and sterilization. Prior arts include products that use steam for cleaning and disinfection, such as steam car washers, steam mops, steam sterilizers, steam irons, and steam garment steamers.

However, in the prior art, steam generation typically relies on a boiler-based method where water is stored and heated until it evaporates. The boiler, a vessel used for heating, stores water that is heated either electrically or by fuel until it boils to produce steam. The generated steam is then output through a delivery pipeline. This method is slow because it requires heating all the water in the boiler to a boiling point. Some prior art has attempted to speed up steam production by reducing the boiler volume and replenishing water after evaporation. However, this results in discontinuous steam production. Additionally, controlling the dryness-and-humidity or wetness of the steam produced by these methods is challenging; the steam often has high humidity and is unsuitable for applications requiring dry steam. Furthermore, the steam, being a gas-liquid mixture with high humidity, often fails to reach the high temperatures needed for certain applications. Overall, the steam produced by the prior art lacks precise quality control, limiting the functionality and user experience of steam-based household products on the market.

In view of this, it is necessary to propose a new technical solution to address the aforementioned issues.

### SUMMARY OF THE INVENTION

The present application provides a method for controlling steam generation that produces continuous, stable, and controllable quality steam.

The method is implemented through the following technical solution: A steam generation control method, applied to a steam generation system. The steam generation system includes a liquid inlet, a steam outlet, and a liquid pump, an inlet valve, and a steam heater connected between the liquid inlet and the steam outlet. The inlet valve is connected between the liquid inlet and the steam heater, and the liquid pump is connected between the inlet valve and the steam heater. The control method includes:
S1, controlling the operation of the liquid pump to drive liquid from the liquid inlet through the inlet valve to the steam heater, which is in a heating state;
S2, during the operation of the liquid pump, controlling the inlet valve to alternately open and close at a preset frequency, causing the liquid to intermittently pass through the inlet valve. The liquid passing through the inlet valve is delivered to the steam heater as a pulsed water flow.

Each pulsed water flow continues to move within the steam heater and is at least partially evaporated and vaporized to generate steam before exiting the steam heater.

As a further improvement, the pipeline between the inlet valve and the liquid pump, at least in the portion near the liquid pump, is filled with liquid, forming a filled section.

As a further improvement, the control method further includes: S3, controlling the heating of the steam heater and monitoring actual temperature of the steam heater; when the actual temperature of the steam heater reaches a preset temperature, executing the aforementioned steps S1 and S2.

As a further improvement, the steam outlet has open and closed states. When the steam outlet is in the closed state, the control method includes: controlling the steam heater to be in a heating state and intermittently operating the liquid pump and the inlet valve to intermittently supply water to the steam heater.

As a further improvement, when the steam outlet is in the closed state, the control method includes: controlling the steam heater to be in a heating state and monitoring the actual temperature of the steam heater. When the actual temperature of the steam heater reaches a first preset temperature, controlling the liquid pump to supply water to the steam heater; and when the actual temperature of the steam heater is below the first preset temperature, controlling the liquid pump to stop supplying water to the steam heater.

As a further improvement, when the steam outlet is in the closed state, the duration for which the actual temperature of the steam heater is below the first preset temperature is greater than the duration for which the actual temperature of the steam heater is at the first preset temperature.

As a further improvement, when the steam outlet is in the open state, the control method includes: controlling the steam heater to be in a heating state and continuously operating the liquid pump to supply water to the steam heater. The relationship between the heating of the steam heater and the water supply by the liquid pump is configured such that the amount of heat generated by the steam heater per unit time is not less than the amount of heat consumed by the water supplied by the liquid pump per unit time.

As a further improvement, when the steam outlet is in the open state, the control method includes: controlling the steam heater to be in a heating state, continuously operating the liquid pump to supply water to the steam heater, and monitoring the actual temperature of the steam heater. When the actual temperature of the steam heater reaches a second preset temperature, controlling the steam heater to maintain the second preset temperature.

As a further improvement, the first preset temperature is not less than the second preset temperature, with the second preset temperature being a temperature range.

As a further improvement, the steam generation system includes a steam gun head, with the steam outlet located within the steam gun head. The steam gun head has a trigger for switching the steam outlet between open and closed states.

As a further improvement, the steam gun head is provided with a mechanical switch and an electrical switch. The mechanical switch is positioned at the steam outlet to control the opening and closing of the steam outlet. The electrical switch is electrically connected to the liquid pump to control operation of the liquid pump. The trigger simultaneously activates both the mechanical switch and the electrical switch.

As a further improvement, the intermittent operation frequency of the liquid pump and the inlet valve is lower than the preset frequency for open-close alternating operation of the inlet valve.

As a further improvement, the control method includes: when the steam pressure within the steam generation system reaches a preset value, releasing steam through a relief valve to relieve the pressure.

As a further improvement, the liquid pump is an electromagnetic pump, and the inlet valve is an electromagnetic valve. The electromagnetic pump and the electromagnetic valve are controlled in synchronization.

As a further improvement, the control method includes: detecting the quality parameter information of the generated steam, as well as the operating parameter information of the steam heater and/or the inlet valve. If the detected steam quality parameter information does not meet the preset requirements, adjusting the operating parameter information of the steam heater and/or the inlet valve until the detected steam quality parameter information meets the preset requirements.

As a further improvement, the steam quality parameter information includes the steam dryness fraction; the operating parameter information of the steam heater includes the temperature value of the steam heater. When the detected steam dryness fraction exceeds the preset requirement, increasing the temperature value of the steam heater; when the detected steam dryness fraction is below the preset requirement, decreasing the temperature value of the steam heater.

As a further improvement, the operating parameter information of the inlet valve includes at least one of the following: the open-close frequency of the inlet valve, the duration of the open-close state, and the water intake volume.

As a further improvement, the control method further includes: detecting the temperature of the liquid before it enters the steam generation system, and setting the preset target temperature of the steam heater based on the temperature of the liquid. When the actual temperature of the steam heater reaches the preset target temperature, controlling the inlet valve to alternately open and close to supply water to the steam heater.

As a further improvement, the control method includes:

Controlling the inlet valve to alternately open and close at a first preset frequency, causing the liquid to intermittently pass through the inlet valve, forming a pulsed water flow that is delivered to the steam heater in a heating state; each pulsed water flow is at least partially evaporated into steam before exiting the steam heater, producing steam with a first steam dryness fraction;
controlling the inlet valve to alternately open and close at a second preset frequency, causing the liquid to intermittently pass through the inlet valve, forming a pulsed water flow that is delivered to the steam heater in a heating state; each pulsed water flow is at least partially evaporated into steam before exiting the steam heater, producing steam with a second steam dryness fraction.

The first preset frequency is different from the second preset frequency, and/or the first preset temperature is different from the second preset temperature.

As a further improvement, the control method includes:
receiving a trigger command to generate steam with a first steam dryness fraction;
controlling the liquid pump to operate, and during the operation of the liquid pump, controlling the inlet valve to alternately open and close with a first opening duration and a first closing duration, forming a first pulsed water flow; the first pulsed water flow is delivered to the steam heater in a heating state for evaporation to produce the steam with a first steam dryness fraction;
receiving a trigger command to generate steam with a second steam dryness fraction;
controlling the liquid pump to operate, and during the operation of the liquid pump, controlling the inlet valve to alternately open and close with a second opening duration and a second closing duration, forming a second pulsed water flow; the second pulsed water flow is delivered to the steam heater in a heating state, where it is evaporated to produce steam with a second steam dryness fraction.

The first and second pulsed water flows both exhibit alternating strong and weak water flow stages, with strong water flow stages occurring when the inlet valve is open, and weak water flow stages occurring when the inlet valve is closed.

The second opening duration is shorter than the first opening duration, and the second closing duration is longer than the first closing duration, resulting in the steam generated with the second steam dryness fraction having lower moisture content than the steam generated with the first steam dryness fraction.

As a further improvement, the control method includes: pre-storing an information table that correlates steam dryness fractions with the preset temperatures of the steam heater and/or the preset frequencies of the inlet valve. When a command to generate steam with a certain dryness-and-dryness-and-humidity value is triggered, the corresponding data from the information table is retrieved, and the preset temperature of the steam heater and/or the preset frequency of the inlet valve is set accordingly.

The steam generation control method provided in this application controls liquid to be delivered as a pulsed water flow to the steam heater operating in a heating state. Each pulsed water flow continuously flows within the steam heater and is at least partially evaporated before exiting the steam heater. The control method uses pulsed water flow for water intake, ensuring that each pulsed water flow, while continuously flowing within the steam heater, is heated and evaporated. This approach allows for rapid steam generation, with the produced steam being continuous and of stable, controllable quality.

### BRIEF DESCRIPTION OF DRA WINGS

To more clearly illustrate the technical solutions in the embodiments of this application, the following provides a brief introduction to the accompanying drawings required for the description of the embodiments. It is evident that the accompanying drawings described below are only some embodiments of this application, and for those skilled in the art, other drawings can be obtained based on these drawings without creative effort.

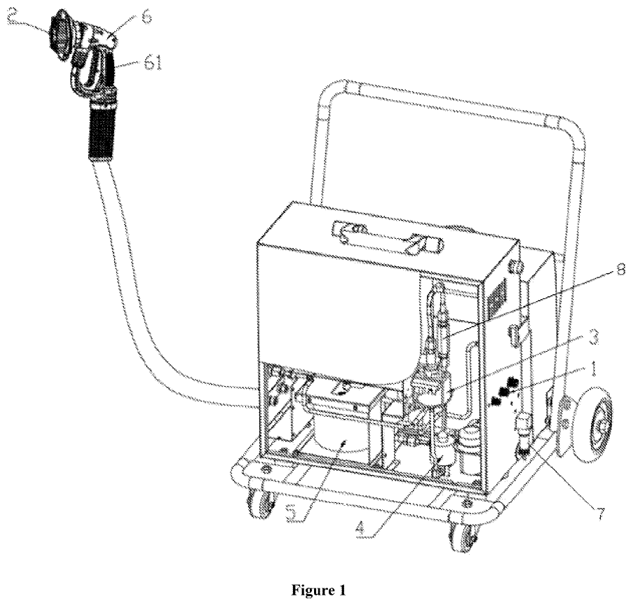

FIG. 1 is a perspective view of the steam generation system applied in steam equipment according to the control method of this application.

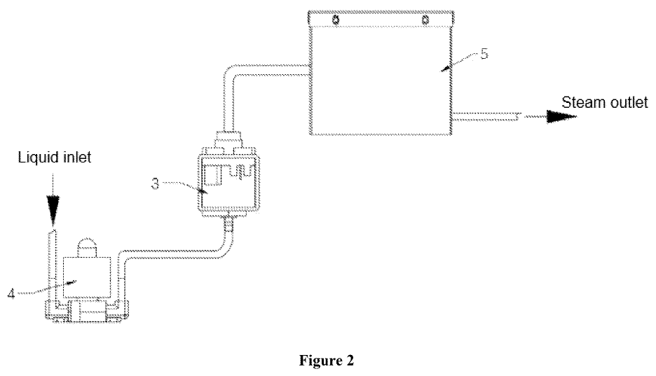

FIG. 2 is a schematic diagram of the steam generation system applied in the control method of this application.

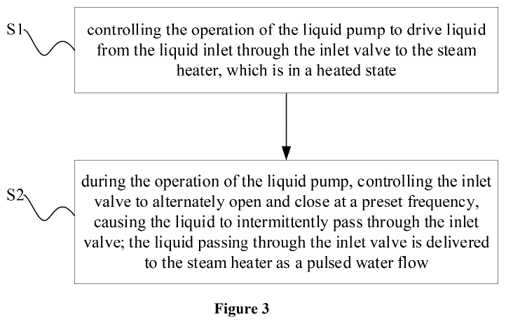

FIG. 3 is a flowchart of an embodiment of the control method of this application.

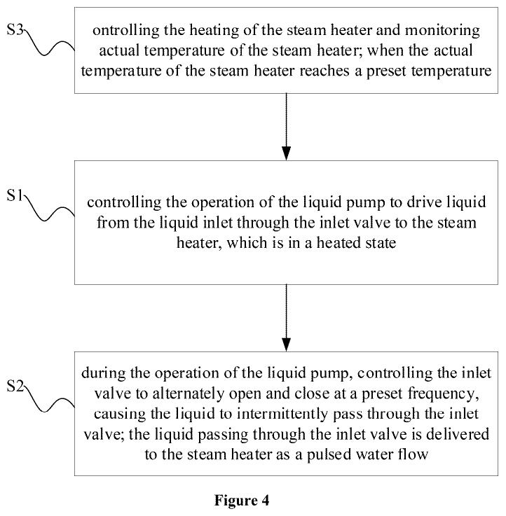

FIG. 4 is a flowchart of another embodiment of the control method of this application.

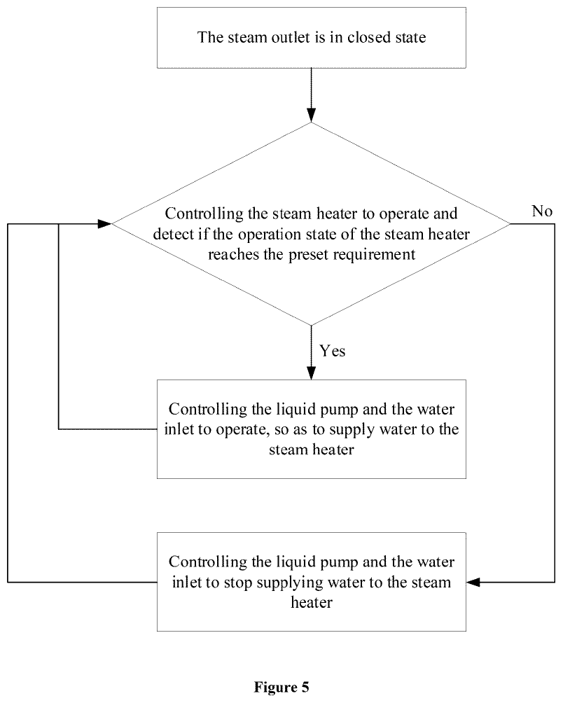

FIG. 5 is a flowchart of yet another embodiment of the control method of this application.

### REFERENCE NUMERALS

1—Liquid Inlet; 2—Steam Outlet; 3—Liquid Pump; 4—Inlet Valve; 5—Steam Heater.

### DETAILED DESCRIPTION OF THE INVENTION

The following detailed description pertains to exemplary embodiments, illustrated in the accompanying drawings. Unless otherwise indicated, the same or similar elements in different figures are denoted by the same reference numerals. The implementation methods described in the following exemplary embodiments do not represent all possible implementations consistent with this application; they are merely examples of devices and methods consistent with some aspects of this application.

In conjunction with the accompanying drawings, the steam generation control method provided by this application is described in detail. The features of the following embodiments can be combined with each other where they do not conflict.

Referring to FIGS. 1 to 5, this application provides a steam generation control method applicable to a steam generation system. As illustrated in FIGS. 1 and 2, which provide an embodiment of the steam generation system for the steam generation control method described in this application, the system includes a liquid inlet 1, a steam outlet 2, and a connection between the liquid inlet 1 and the steam outlet 2 comprising a liquid pump 3, an inlet valve 4, and a steam heater 5. The inlet valve 4 is connected between the liquid inlet 1 and the steam heater 5. The liquid inlet 1, inlet valve 4, liquid pump 3, steam heater 5, and steam outlet 2 are interconnected by pipelines. Liquid enters through the liquid inlet 1, passes through the inlet valve 4 and liquid pump 3, and then enters the steam heater 5. In the steam heater 5, the liquid is heated and evaporated into steam before being discharged through the steam outlet 2. The liquid pump 3, also referred to as a water pump, controls the intake or stoppage of water. In one embodiment, the liquid pump 3 is an electromagnetic pump. The inlet valve 4 controls the volume and manner of water intake. In one embodiment, the inlet valve 4 is an electromagnetic valve. The liquid pump 3 is positioned between the inlet valve 4 and the steam heater 5. During operation, the liquid pump 3 generates pressure to drive the liquid into the steam heater 5. Since the outlet of the liquid pump 3 is directly connected to the steam heater 5, the pressure generated by the liquid pump 3 must be sufficient to overcome the pressure within the pipeline at the connection between the steam heater 5 and the liquid pump 3 to prevent backflow. Additionally, the presence of the liquid pump 3 between the inlet valve 4 and the steam heater 5 protects the inlet valve 4 from steam pressure from the steam heater 5, ensuring the longevity and stability of the inlet valve 4. The liquid pump 3 and the inlet valve 4 are controlled by correlated signals to ensure synchronized and coordinated operation.

### Embodiment 1

Referring to FIG. 3, the control method includes: S1, controlling the operation of the liquid pump 3 to drive liquid from the liquid inlet 1 through the inlet valve 4 and liquid pump 3 to the steam heater 5, which is in a heating stateheating state; S2, during the operation of the liquid pump 3, controlling the inlet valve 4 to alternately open and close at a preset frequency, causing the liquid to intermittently pass through the inlet valve 4. The liquid passing through the inlet valve 4 forms a pulsed water flow, which is delivered to the steam heater 5. Each pulsed water flow continues to move within the steam heater 5 and is at least partially evaporated to form steam before exiting the steam heater 5.

In the control method provided by this application, water is introduced in a pulsed flow manner. Each pulsed water flow continuously moves within the steam heater 5, where it is heated and evaporated, leading to rapid steam production. The pulsed water flow, characterized by alternating strong and weak flows, enters the steam heater 5. This allows the steam heater 5 to quickly heat up and return to a balance temperature that can produce stable steam quality after the “peak segment” of each pulsed water flow is evaporated and before the arrival of the next “peak segment.” This process ensures that the state of the steam heater 5 is consistent or nearly consistent each time a pulsed water flow enters, preventing a temperature drop due to the evaporation of preceding water flow, thereby producing steam with lower humidity and ensuring continuous, stable, and controllable steam quality.

In this embodiment, the liquid pump 3 is positioned between the inlet valve 4 and the steam heater 5. The liquid pump 3 operates continuously during water intake control rather than intermittently, providing constant water pressure to prevent steam backflow into the steam heater 5, which also reduces wear and tear on the liquid pump 3. Since the inlet valve 4 only serves to control the flow of water without providing the driving force for the liquid flow, it does not require a large starting force. Therefore, the open-close frequency of the inlet valve 4 can be much higher than the operating frequency of the liquid pump 3. In this embodiment, the pipeline between the inlet valve 4 and the liquid pump 3 is filled with liquid, or at least a section near the liquid pump 3 is filled with liquid. During the operation of the liquid pump 3, the alternate opening and closing of the inlet valve 4 create two alternating states for the liquid between the inlet valve 4 and the liquid pump 3: one where both the liquid pump 3 and inlet valve 4 are open, and the other where the liquid pump 3 is open but the inlet valve 4 is closed. When both the liquid pump 3 and the inlet valve 4 are open, the liquid between them flows freely. The driving force from the liquid pump 3 can push a certain amount of liquid through the liquid pump 3 toward the steam heater 5 while drawing in liquid from the liquid inlet 1 through the inlet valve 4 into the section between the liquid pump 3 and inlet valve 4. In this state, the flow towards the steam heater 5 is greater, forming the strong segment of the pulsed flow. When the liquid pump 3 is open, but the inlet valve 4 is closed, the upstream liquid is cut off, creating a closed environment between the liquid pump 3 and the inlet valve 4. The liquid pump 3 must overcome negative pressure to move the liquid toward the steam heater 5, resulting in a smaller flow rate, forming the weak segment of the pulsed flow. When the inlet valve 4 alternately opens and closes at a certain frequency, the water flow from the liquid pump 3 forms a continuous pulsed flow with alternating strong and weak segments, delivered to the steam heater 5. This approach ensures that the water entering the steam heater 5 is continuous, and even a small amount of water can generate a large amount of steam. Therefore, the steam produced does not exhibit noticeable interruptions or variations in quantity, resulting in continuous and stable steam production.

### Embodiment 2

Referring to FIG. 4, in a further improved embodiment of the control method described in this application, the method for generating steam includes: S3, controlling the heating of the steam heater 5 and monitoring the actual temperature of the steam heater 5. When the actual temperature of the steam heater 5 reaches the preset temperature, the above-mentioned steps S1 and S2 are executed.

In this embodiment, by preheating the steam heater 5 and controlling water intake only when the preheating reaches the preset temperature, it ensures that the incoming water can immediately produce steam of the desired quality. Compared to some prior art where water intake triggers heater activation, this approach avoids issues with initial steam quality instability and reduces water wastage. In this embodiment, the steam quality includes the steam dryness fraction of the steam, and the preset temperature is set in relation to the amount of water intake controlled by the liquid pump 3 and the inlet valve 4, as well as the desired steam dryness fraction of the steam. When the water intake amount controlled by the liquid pump 3 and the inlet valve 4 is constant, the preset temperature of the steam heater 5 is set higher to produce drier steam (i.e., steam with lower humidity). Conversely, to produce wetter steam (i.e., steam with higher humidity), the preset temperature of the steam heater 5 is set lower. Furthermore, in this embodiment, the controller automatically triggers the operation of the liquid pump 3 and the inlet valve 4 for water intake based on the detected actual temperature of the steam heater 5, achieving precise timing for water intake control. This approach prevents steam quality instability due to premature water intake and avoids overheating of the steam heater 5 due to delayed water intake.

### Embodiment 3

Referring to FIG. 5, in a further improved embodiment based on the control method shown in FIG. 3, the steam outlet 2 has an open state and a closed state. When the steam outlet 2 is in a closed state, the control method includes controlling the steam heater 5 to remain in a heating stateheating state and intermittently operating the liquid pump 3 and the inlet valve 4 to intermittently supply water to the steam heater 5.

In a specific embodiment, the open and closed states of the steam outlet 2 are manually controlled by the user, allowing the user to control the shutdown and discharge of steam at any time. For example, in one embodiment, the liquid evaporated into steam in the steam heater 5 is delivered through a steam pipeline to a handheld steam gun head 6 used by the user. The steam outlet 2 is located within the steam gun head 6, which is provided with a trigger 61. The user can squeeze and release the trigger 61 to switch the steam outlet 2 between open and closed states. In one embodiment, the steam gun head 6 includes both a mechanical switch and an electrical switch. The mechanical switch is positioned at the steam outlet 2 to control opening and closing of the steam outlet 2, while the electrical switch is electrically connected to the liquid pump 3 to control operation of the liquid pump 3. The trigger simultaneously activates both the mechanical switch and the electrical switch.

In the embodiment shown in FIG. 5, when the steam outlet 2 is in a closed state, the steam generated within the steam generation system cannot be discharged through the steam outlet 2. If steam continues to be produced in large quantities under these conditions, it can lead to excessively high pressure within the steam generation system, posing safety risks to both the system and the user. In this embodiment, when the steam outlet 2 is closed, the method involves controlling the steam heater 5 to remain in a heating stateheating state and intermittently operating the liquid pump 3 and the inlet valve 4 to intermittently supply water to the steam heater 5. This setup has the following benefits: Keeping the steam heater 5 in a heating stateheating state ensures that steam can be promptly produced when the user opens the steam outlet 2. Users frequently need to start and stop the steam flow, and if the steam heater 5 stops heating while the steam outlet 2 is closed, the temperature of the steam heater 5 drops. If the steam outlet 2 remains closed for an extended period, the temperature of the steam heater 5 decreases significantly, resulting in steam that does not meet the desired quality when the steam outlet 2 is reopened. For instance, if a user closes the steam outlet 2 for a period while using drier steam for dry cleaning clothes, reopening it may result in steam with higher humidity, causing the clothes to become damp. On the other hand, if the steam heater 5 continues heating and water is continuously supplied, a large amount of steam would be produced, potentially raising the pressure within the steam generation system to unsafe levels. If no water is supplied, the steam heater 5 could overheat due to dry firing. Therefore, in this embodiment, while keeping the steam heater 5 heated, the method controls the liquid pump 3 and the inlet valve 4 to intermittently supply water to the steam heater 5. This approach prevents excessive steam generation when the outlet is closed, thereby avoiding the risk of pressure buildup. It also prevents the steam heater 5 from overheating due to lack of water, maintaining system safety and steam quality.

Furthermore, the control of the steam heater 5 in a heating state and the intermittent operation of the liquid pump 3 and the inlet valve 4 to supply water intermittently to the steam heater 5 includes controlling the steam heater 5 to operate and monitoring operational state of the steam heater 5. When the operational state of the steam heater 5 reaches a preset condition, the liquid pump 3 and the inlet valve 4 are controlled to supply water to the steam heater 5. If the operational state of the steam heater 5 does not meet the preset condition, the liquid pump 3 and the inlet valve 4 are controlled to stop supplying water to the steam heater 5. This intermittent water supply process is automatically triggered by a controller based on the detected operational state of the steam heater 5, effectively controlling and maintaining the operational state of the steam heater 5, preventing actual operational state of the steam heater 5 from deviating excessively from the state required to produce steam of the preset quality, ensuring the continuous production of quality-controlled steam. The preset condition of the operational state can be based on reaching a preset time, preset pressure, or preset temperature, or a combination of these factors. In one embodiment, the operational state of the steam heater 5 reaches the preset condition when the actual temperature of the steam heater 5 reaches a first preset temperature. Specifically, when the steam outlet 2 is closed, water intake is controlled based on the temperature of the steam heater 5. When the temperature of the steam heater 5 reaches the first preset temperature, the liquid pump 3 and inlet valve 4 are controlled to supply water, during which the temperature of the steam heater 5 may drop below the first preset temperature, prompting the liquid pump 3 and inlet valve 4 to stop water intake. Once the temperature rises back to the first preset temperature, water intake resumes, achieving intermittent water supply. This setup ensures that when the steam outlet 2 is closed, there is no immediate need to discharge steam, and temperature-controlled water intake maintains the “stored” steam within the system near the desired quality. When the steam outlet is open and steam is urgently needed, the “stored” steam can be immediately used, while new steam is generated, ensuring no delay in steam production. During the intermittent water supply process, the primary control of water intake and stoppage is managed by the liquid pump 3, with the inlet valve 4 primarily facilitating the pulsed water flow during the water intake phase. In other words, the frequency of intermittent operation of the liquid pump 3 and inlet valve 4 is lower than the preset frequency for the alternating open-close operation of the inlet valve 4, meaning that during one cycle of intermittent water intake, the inlet valve 4 still undergoes multiple alternating open-close cycles.

As described above, although intermittent water supply can prevent the generation of a large amount of steam, some steam will still be produced. Therefore, in one embodiment, when the steam outlet 2 is closed, the duration during which the actual temperature of the steam heater 5 remains below the first preset temperature is longer than the duration during which the actual temperature is at the first preset temperature. This means that during intermittent water supply, the period of water intake is shorter than the period of no water intake, thereby reducing the frequency of water intake and the amount of steam produced. Further, in this embodiment, the steam generation system also includes a pressure relief valve 7. The control method additionally includes releasing steam through the pressure relief valve 7 to relieve pressure when the steam pressure within the steam generation system reaches a preset value.

When the steam outlet 2 is in an open state, the control method includes controlling the steam heater 5 to remain in a heating state and operating the liquid pump 3 and the inlet valve 4 to supply water. The relationship between the heating provided by the steam heater 5 and the water intake controlled by the liquid pump 3 and the inlet valve 4 is configured such that the amount of heat generated by the steam heater 5 per unit time is not less than the amount of heat consumed by the water intake controlled by the liquid pump 3 and the inlet valve 4 per unit time.

Specifically, when the steam outlet 2 is open, continuous water supply to the steam heater 5 is maintained to ensure continuous steam production. To prevent the temperature of the steam heater 5 from dropping during continuous water intake, the heat generated by the steam heater 5 per unit time must be at least equal to the heat consumed by the water intake controlled by the liquid pump 3 and the inlet valve 4 per unit time. This configuration ensures that during continuous water intake, the steam heater 5 can increase from a temperature below the preset temperature to the preset temperature and maintain it within the preset temperature range. The preset temperature may be defined as a temperature range, where “heating to the preset temperature” refers to heating to the lower limit of this range, and “maintaining the preset temperature” refers to keeping the temperature within the upper and lower limits of this range. Additionally, it should be noted that the term “continuous water supply” here is relative to the intermittent water supply when the steam outlet 2 is closed. This continuous water supply does not change the pulsed water flow method controlled by the inlet valve 4.

When the steam outlet 2 is in an open state, the control method includes controlling the steam heater 5 to remain in a heating state, and continuously operating the liquid pump 3 to supply water to the steam heater 5. The actual temperature of the steam heater 5 is monitored, and when it reaches a second preset temperature, the steam heater is controlled to maintain this second preset temperature. The first preset temperature is not less than the second preset temperature, with the second preset temperature being defined as a temperature range.

### Embodiment 4

The steam generation control method provided in this application can be used to produce steam with one or more preset steam dryness fraction. The preset steam dryness fraction of the steam are achieved by matching the preset frequency of the open-close operation of the inlet valve 4 with the heating of the steam heater 5. For example, when the inlet valve 4 is controlled to alternately open and close at a first preset frequency, the liquid passing through the inlet valve 4 is delivered in a pulsed flow to the steam heater 5 set at a first preset temperature, resulting in steam with a first steam dryness fraction. When the inlet valve 4 is controlled to alternately open and close at a second preset frequency, the liquid passing through the inlet valve 4 is delivered in a pulsed flow to the steam heater 5 set at a second preset temperature, resulting in steam with a second steam dryness fraction. The first preset frequency differs from the second preset frequency, and/or the first preset temperature differs from the second preset temperature, thus achieving different steam dryness fractions for the steam. Since the preset frequency of the inlet valve 4 affects both the pulsed water flow and the amount of water intake, different steam dryness fractions of steam can also be produced by changing the preset temperature of the steam heater 5 without altering the preset frequency of the inlet valve 4. For instance, the first and second preset frequencies can be set to the same, with the first preset temperature higher than the second preset temperature, resulting in the steam with first steam dryness fraction having a lower humidity than the steam with second steam dryness fraction.

In one embodiment, the method for generating steam with different steam dryness fraction includes:
receiving a trigger command to produce steam with a first steam dryness fraction;
controlling the operation of the liquid pump 3 and, during operation of the liquid pump 3, controlling the inlet valve 4 to alternately open for a first opening duration and close for a first closing duration, thereby creating a first pulsed water flow; the first pulsed flow is delivered to the steam heater 5 in a heating state; in the steam hater 5, the first pulsed flow is evaporated to produce steam with the first steam dryness fraction;
receiving a trigger command to produce steam with a second steam dryness fraction; and
controlling the operation of the liquid pump 3 and, during operation of the liquid pump 3, controlling the inlet valve 4 to alternately open for a second opening duration and close for a second closing duration, thereby creating a second pulsed water flow; the second pulsed water flow is delivered to the steam heater 5 in a heating state; in the steam heater 5, the second pulsed water flow is evaporated to produce steam with the second steam dryness fraction.

Both the first pulsed water flow and the second pulsed water flow consist of continuous flows with alternating strong and weak segments. The strong segment occurs when the inlet valve 4 is open, forming a strong water flow, and the weak segment occurs when the inlet valve 4 is closed, forming a weak water flow.

The second opening duration is shorter than the first opening duration, and the second closing duration is longer than the first closing duration, resulting in the steam produced with the second steam dryness fraction having lower humidity than the steam produced with the first steam dryness fraction.

The control method of this application generates pulsed water flow with continuous variations in intensity. During one open-close cycle of the inlet valve 4, the reduced water intake during the strong flow segment, caused by a shorter open duration, can be compensated by increasing the water intake during the weak flow segment by lengthening the closed duration of the inlet valve 4. This adjustment helps prevent significant changes in the amount of steam produced when altering the dryness-and-humidity of the steam. Optionally, during one open-close cycle of the inlet valve 4, the open duration can range from 0.01 to 0.2 seconds, and the closed duration can range from 1 to 3 seconds. By adjusting the open and closed durations of the inlet valve 4, the quality of the steam produced can be modified, allowing for the production of steam with varying steam dryness fractions. For example, in the process of controlling the generation of steam with a certain steam dryness fraction, the inlet valve 4 may have an open duration of 0.1 seconds and a closed duration of 1.3 seconds, repeating alternately. In the process of controlling the generation of steam with another steam dryness fraction, the inlet valve may have an open duration of 0.05 seconds and a closed duration of 1.6 seconds, also repeating alternately.

In one embodiment, the heating power of the steam heater 5 remains the same when producing steam with both the first and second steam dryness fractions. That is, the heating power of the steam heater 5 is not differentially controlled based on the dryness-and-humidity of the steam. Instead, the adjustment is made solely through the control of the water intake state via the inlet valve 4. By matching the water intake state and amount controlled by the inlet valve 4 with the rated heating power of the steam heater 5, the temperature of the steam heater 5 can be maintained within a corresponding balance temperature range for different steam dryness fractions. For instance, when producing relatively wetter steam, the balance temperature range of the steam heater 5 is 180° C.-190° C., while for producing relatively drier steam, it is 240° C.-250° C. Furthermore, to prevent the temperature of the steam heater 5 from continually rising due to minimal water intake, which could destabilize it from staying within the balance temperature range, an overheat protection device is provided on the steam heater 5. This device stops the heating of the steam heater 5 when temperature of the steam heater reaches an overheat protection threshold (e.g., 280° C.). In a specific embodiment, the overheat protection device includes a temperature sensor that is electrically connected to the controller of the steam heater 5. The controller uses the temperature detected by the sensor to manage the heating of the steam heater 5.

In this embodiment, the heating power of the steam heater 5 is not differentially controlled when producing steam with varying steam dryness fractions, making the control process simpler. More importantly, this approach enhances precision because steam heaters are often provided with good insulation measures, such as thermal insulation cotton, to achieve better thermal efficiency and reduce heat loss. The good insulation performance of the steam heater 5 results in a slower rate of temperature change (thermal inertia), making it difficult to quickly adjust the temperature by changing the heating power. By controlling the water intake amount and state, this embodiment allows the steam heater 5 to achieve a thermal balance with the incoming water, maintaining the steam heater 5 within a balance temperature range suitable for producing steam with a specific steam dryness fraction.

### Embodiment 5

This embodiment provides a method for controlling steam generation that can produce steam with adjustable quality. The method specifically involves controlling the inlet valve 4 to alternately open and close at a certain frequency, thereby creating a pulsed water flow. As each pulsed water flow moves through the steam heater 5, it is at least partially evaporated to form steam. During the steam generation process, the quality parameters of the steam are monitored, and the operating parameters of the inlet valve are dynamically adjusted to maintain stable steam quality.

Specifically, the control method includes detecting the quality parameter information of the generated steam and the operating parameter information of the steam heater 5 and/or the inlet valve 4. If the detected steam quality parameters do not meet the preset requirements, the operating parameters of the steam heater 5 and/or the inlet valve are adjusted until the detected steam quality parameters meet the preset requirements.

Furthermore, the steam quality parameters include the humidity level of the steam, while the operating parameters of the steam heater 5 include temperature of the steam heater 5. If the detected steam humidity level exceeds the preset required humidity level, the temperature of the steam heater 5 is increased. Conversely, if the detected steam humidity level is below the preset required level, the temperature of the steam heater 5 is decreased. The operating parameters of the inlet valve 4 include the open-close frequency, the duration of the open and close states, and the amount of water intake, at least one of which can be adjusted.

Additionally, to ensure that the initial quality of the steam generated closely matches the desired steam quality, allowing for only minor adjustments to achieve the final desired steam quality, the control method also includes a preheating step where the target temperature of the steam heater 5 is calculated in advance. Specifically, the control method includes: detecting the temperature of the liquid before it enters the steam generation system, and setting a target temperature for the steam heater 5 based on the detected liquid temperature. When the actual temperature of the steam heater 5 reaches this target temperature, the inlet valve 4 is controlled to alternately open and close to supply water to the steam heater 5. Since the initial temperature of the liquid is the most significant factor affecting the heating process of the steam heater 5, this embodiment uses this key factor to preliminarily calculate the approximate temperature value of the steam heater 5 corresponding to the desired steam quality, which is set as the target temperature. Once the steam heater 5 reaches this target temperature, water intake is controlled. While the steam produced at the target temperature of the steam heater 5 may not exactly match the desired steam quality, it is usually quite close, and further adjustments to the preset temperature of the steam heater 5 can quickly achieve the desired steam quality, enhancing the user experience.

In one embodiment, the method for producing steam with stable quality includes: controlling the operation of the liquid pump 3, and during operation of the liquid pump 3, controlling the inlet valve 4 to alternately open and close at a preset frequency, creating a pulsed water flow that is delivered to the steam heater 5 in a heating state, where it is evaporated to produce steam. In each open-close cycle of the inlet valve 4, the valve remains open for a first duration and closed for a second duration.

The quality parameters of the produced steam are monitored; if the detected steam quality parameters do not meet the preset requirements, the duration of the open and closed states of the inlet valve 4 are adjusted until the steam quality parameters meet the preset requirements.

The steam quality parameters include the humidity level of the steam. Adjusting the duration of the open and closed states of the inlet valve 4 involves either increasing the first duration and decreasing the second duration, or decreasing the first duration and increasing the second duration. In one embodiment, a check valve 8 is installed between the liquid pump 3 and the steam heater 5, allowing one-way flow from the liquid pump 3 to the steam heater 5. The check valve 8 prevents backflow of steam, which supports the pulsed water flow method.

From the description of the specific embodiments above, it is evident that the steam generation control method provided by this application involves controlling the liquid to be delivered in pulsed water flows to the steam heater 5, which is in a heating state. Each pulsed water flow continues to move within the steam heater 5 and is at least partially evaporated before exiting the steam heater 5. This control method, which uses pulsed water flows, ensures that each flow is heated and evaporated within the steam heater 5, resulting in rapid steam production, continuous output, and stable, controllable steam quality.

The above description is merely a preferred embodiment of this application and is not intended to limit the scope of the application in any way. Although this application has been disclosed with preferred embodiments, it is not limited to these embodiments. Any person skilled in the art may make slight modifications or equivalent changes to these embodiments based on the disclosed content without departing from the scope of the technical solution of this application. Any simple modifications, equivalent changes, and adjustments made to the above embodiments without departing from the technical essence of this application are still within the scope of the technical solutions claimed in this application.

1. A steam generation control method applied to a steam generation system, wherein the steam generation system comprises a liquid inlet, a steam outlet, and a liquid pump, an inlet valve, and a steam heater connected between the liquid inlet and the steam outlet; wherein the inlet valve is connected between the liquid inlet and the steam heater; and the liquid pump is connected between the inlet valve and the steam heater, characterized in that the control method comprises:
S1, controlling the liquid pump to operate to drive a liquid from the liquid inlet through the inlet valve to the steam heater operating in a heating state;
S2, during the operation of the liquid pump, controlling the inlet valve to alternate between open and close at a preset frequency, such that the liquid intermittently passes through the inlet valve, and the liquid after passing through the inlet valve is transported to the steam heater as a pulsed water flow;
wherein each pulsed water flow continuously flows within the steam heater and is at least partially evaporated into steam before discharging from the steam heater;
the control method further comprises:
S3, controlling the steam heater to heat and detecting an actual temperature of the steam heater; executing the above S1 and S2 steps when the actual temperature of the steam heater reaches a preset temperature;
the steam outlet has an open state and a closed state; in the closed state of the steam outlet, the control method comprises: controlling the steam heater to be in a heating state and controlling the liquid pump and the inlet valve to operate intermittently to intermittently supply water to the steam heater.

2. The steam generation control method according to claim 1, characterized in that in the closed state of the steam outlet, the control method comprises: controlling the steam heater to operate in a heating state and detecting the actual temperature of the steam heater; when the actual temperature of the steam heater reaches a first preset temperature, controlling the liquid pump to supply water to the steam heater, and when the actual temperature of the steam heater does not reach the first preset temperature, controlling the liquid pump to stop supplying water to the steam heater;
in the closed state of the steam outlet, the duration of the actual temperature of the steam heater being below the first preset temperature is longer than the duration of the actual temperature being at the first preset temperature.

3. The steam generation control method according to claim 2, characterized in that in the open state of the steam outlet, the control method comprises: controlling the steam heater to operate in a heating state, controlling the liquid pump to continuously operate to supply water to the steam heater; detecting the actual temperature of the steam heater, and when the actual temperature of the steam heater reaches a second preset temperature, controlling the steam heater to maintain the second preset temperature;
the first preset temperature is not less than the second preset temperature, and the second preset temperature is a temperature range.

4. The steam generation control method according to claim 3, characterized in that the steam generation system comprises a steam nozzle; the steam outlet is disposed within the steam nozzle; the steam nozzle has a trigger for controlling the steam outlet to switch between the open state and the closed state;
the steam nozzle is provided with a mechanical switch and an electric switch, the mechanical switch is disposed at the steam outlet for controlling the opening and closing of the steam outlet; the electric switch is electrically connected to the liquid pump for controlling the operation of the liquid pump; and the trigger simultaneously drives the mechanical switch and the electric switch.

5. The steam generation control method according to claim 1, characterized in that the frequency of intermittent operation of the liquid pump and the inlet valve is less than the preset frequency of the open and close cycles of the inlet valve.

6. The steam generation control method according to claim 1, characterized in that the control method comprises: when the steam pressure in the steam generation system reaches a preset value, discharging steam through a pressure relief valve to relieve pressure.

7. The steam generation control method according to claim 1, characterized in that the liquid pump is an electromagnetic pump, the inlet valve is an electromagnetic valve, and the electromagnetic pump and the electromagnetic valve are controlled in linkage.

8. The steam generation control method according to claim 1, characterized in that the control method comprises: detecting the quality parameter information of the generated steam, and the operating parameter information of the steam heater and/or the inlet valve; if the detected quality parameter information of the steam does not meet the preset requirements, adjusting the operating parameter information of the steam heater and/or the inlet valve until the detected quality parameter information of the steam meets the preset requirements.

9. The steam generation control method according to claim 8, characterized in that the steam quality parameter information includes steam humidity, and the steam heater operating parameter information includes the temperature of the steam heater; if the detected steam humidity is greater than the humidity under the preset requirements, increasing the temperature of the steam heater; if the detected steam humidity is less than the humidity under the preset requirements, decreasing the temperature of the steam heater.

10. The steam generation control method according to claim 8, characterized in that the inlet valve operating parameter information includes at least one of the open-close frequency, open-close duration, and water supply amount of the inlet valve.

11. The steam generation control method according to claim 8, characterized in that the steam generation control method further comprising: detecting the temperature of the liquid before it enters the steam generation system, and setting the preset target temperature of the steam heater according to the temperature of the liquid; when the actual temperature of the steam heater reaches the preset target temperature, controlling the inlet valve to operate alternately open and close to supply water to the steam heater.

12. The steam generation control method according to claim 1, characterized in that the control method comprises:
controlling the inlet valve to operate alternately open and close at a first preset frequency, so that the liquid intermittently passes through the inlet valve, and the liquid after passing through the inlet valve is transported to the steam heater at a first preset temperature as a pulsed water flow; each pulsed water flow being at least partially evaporated before exiting the steam heater to produce steam with a first steam dryness fraction;
controlling the inlet valve to operate alternately open and close at a second preset frequency, so that the liquid intermittently passes through the inlet valve, and the liquid after passing through the inlet valve is transported to the steam heater at a second preset temperature as a pulsed water flow; each pulsed water flow being at least partially evaporated before exiting the steam heater to produce steam with a second steam dryness fraction;
wherein the first preset frequency differs from the second preset frequency and/or the first preset temperature differs from the second preset temperature.

13. The steam generation control method according to claim 1, characterized in that the control method comprises:
receiving a trigger command to generate steam with a first steam dryness fraction;
controlling the liquid pump to operate, and during the operation of the liquid pump, controlling the inlet valve to operate alternately open and close for a first opening duration and a first closing duration to form a first pulsed water flow; the first pulsed water is delivered to the steam heater operating in a heating state and evaporated to produce steam with a first steam dryness fraction;
receiving a trigger command to generate steam with a second steam dryness fraction;
controlling the liquid pump to operate, and during the operation of the liquid pump, controlling the inlet valve to operate alternately open and close for a second opening duration and a second closing duration to form a second pulsed water flow, which is delivered to the steam heater operating in a heating state and evaporated to produce steam with a second steam dryness fraction;
wherein both the first pulsed water flow and the second pulsed water flow are continuous water flows with alternating flow rate, with a strong water flow phase formed when the inlet valve is open, and a weak water flow phase formed when the inlet valve is closed;
wherein the second opening duration is shorter than the first opening duration, and the second closing duration is longer than the first closing duration, resulting in the steam with a second steam dryness fraction having lower humidity than the steam with a first steam dryness fraction.

14. The steam generation control method according to claim 12, characterized in that the control method comprises: pre-storing an information table correlating steam dryness fractions with the preset temperatures of the steam heater and/or the preset frequencies of the inlet valve; when a steam command is triggered to generate steam of a certain preset steam dryness fraction, retrieving the corresponding data from the information table and accordingly setting the preset temperature of the steam heater and/or the preset frequency of the inlet valve.
